(19) United States
(12) Patent Application Publication
(10) Pub. No.: US 2021/0292217 A1
(43) Pub. Date: Sep. 23, 2021

(54) TEMPERED GLASS AND GLASS TO BE TEMPERED

(71) Applicant: Nippon Electric Glass Co., Ltd., Shiga (JP)

(72) Inventor: Ryota SUZUKI, Shiga (JP)

(21) Appl. No.: 17/260,299

(22) PCT Filed: Jun. 25, 2019
(86) PCT No.: PCT/JP2019/025026

§ 371 Date: Jan. 14, 2021

(30) Foreign Application Priority Data
Jul. 27, 2018 (JP) 2018-140878

(51) Int. Cl. C03B 23/023; C03C 3/091; C03C 3/085

(52) U.S. Cl. CPC C03B 23/023; C03C 3/085; C03C 3/091

(57) ABSTRACT

A tempered glass of the present invention includes as a glass composition, in terms of mass %, 40% to 60% of SiO₂, 15% to 25% of Al₂O₃, 0% to 13.5% of B₂O₃, 12% to 24% of Na₂O, and 0% to less than 3% of MgO.

### TECHNICAL FIELD

The present invention relates to a tempered glass and a glass to be tempered, and more particularly, to a tempered glass and a glass to be tempered which are suitable for, for example, a cover glass for a mobile phone, exterior parts for a mobile PC and the like, and window glasses for an automobile, a train, a ship, and the like.

### BACKGROUND ART

Mobile phones having touch panels mounted thereon have been widespread. A glass subjected to tempering treatment, such as ion exchange treatment (so-called tempered glass), is used for cover glasses for such mobile phones. The tempered glass is high in mechanical strength as compared to an untempered glass, and hence is suitable for this application (see Patent Literature 1 and Non Patent Literature 1).

In recent years, touch panels are being mounted for applications other than mobile phones as well, and hence, tempered glasses each having a bent portion are necessary in some of the applications (e.g., exterior parts for a mobile PC and the like). The tempered glass having a bent portion may be produced by, for example, forming molten glass to obtain a glass to be tempered in a flat sheet shape, and then subjecting the glass to be tempered to thermal bending processing to form a bent portion, followed by ion exchange treatment (see Patent Literatures 2 and 3).

In addition, a tempered glass having a curved portion is used as a window glass for an automobile (see Non Patent Literatures 2 and 3). The tempered glass having a curved portion may be produced by, for example, forming molten glass to obtain a glass to be tempered in a flat sheet shape, and then subjecting the glass to be tempered to thermal bending processing to form a curved portion, followed by ion exchange treatment.

### CITATION LIST

Patent Literature 1: JP 2006-83045 A
Patent Literature 2: U.S. Pat. No. 7,168,047 B1
Patent Literature 3: JP 2001-247342 A
Non Patent Literature 1: Tetsuro Izumitani et al., “New glass and physical properties thereof,” First edition, Management System Laboratory. Co., Ltd., Aug. 20, 1984, p. 451-498
Non Patent Literature 2: Thomas Cleary et al., Lighter, tougher, and optically advantaged: How an innovative combination of materials can enable better car windows today, American Ceramic Society Bulletin, Vol. 96, No. 4, P 20-27
Non Patent Literature 3: “Automotive Glass”, [online], [retrieved on Jul. 15, 2018], Internet <URL: http://www.agc.com/products/automotive/index.html>

### SUMMARY OF INVENTION

### Technical Problem

Incidentally, a compressive stress layer is formed in the surface of the tempered glass. In general, the mechanical strength of the tempered glass can be increased by increasing the compressive stress value and depth of layer of the compressive stress layer.

In order to increase the compressive stress value and depth of layer of the compressive stress layer, it is effective to increase the content of Al₂O₃ in a glass composition, to thereby improve ion exchange performance. However, when the content of Al₂O₃ in the glass composition is increased, a softening point is increased, and bending processability is liable to be reduced. As a result, it becomes difficult to form a bending processed portion, such as a bent portion or a curved portion, in the glass to be tempered.

The present invention has been made in view of the above-mentioned circumstances, and a technical object of the present invention is to provide a tempered glass and a glass to be tempered which can achieve both ion exchange performance and bending processability.

### Solution to Problem

The inventor of the present invention has made extensive investigations. As a result, the inventor has found that both the ion exchange performance and the bending processability can be achieved by restricting the glass composition within a predetermined range. The finding is proposed as the present invention. That is, according to one embodiment of the present invention, there is provided a tempered glass, comprising as a glass composition, in terms of mass %, 40% to 60% of SiO₂, 15% to 25% of Al₂O₃, 0% to 13.5% of B₂O₃, 12% to 24% of Na₂O, and 0% to less than 3% of MgO.

In the tempered glass according to the one embodiment of the present invention, the contents of Al₂O₃, B₂O₃, Na₂O, and MgO are restricted to 15 mass % or more, 13.5 mass % or less, 12 mass % or more, and less than 3 mass %, respectively. With this, ion exchange performance can be improved.

Further, in the tempered glass according to the one embodiment of the present invention, the contents of SiO₂, Al₂O₃, and Na₂O are restricted to 60 mass % or less, 25 mass % or less, and 12 mass % or more, respectively. With this, bending processability can be improved.

In addition, it is preferred that the tempered glass according to the one embodiment of the present invention comprise as a glass composition, in terms of mass %, 40% to 53% of SiO₂, 15% to 21% of Al₂O₃, 4% to 13.5% of B₂O₃, 17% to 24% of Na₂O, and 0.1% to less than 3% of MgO.

In addition, it is preferred that the tempered glass according to the one embodiment of the present invention comprise as a glass composition, in terms of mass %, 50% to 60% of SiO₂, 21% to 25% of Al₂O₃, 0% to 4% of B₂O₃, 3% to 6% of Li₂O, 12% to 17% of Na₂O, 0% to less than 3% of MgO, 0.1% to 3.50 of P₂O₃, and 0.1% to 5% of ZnO.

In addition, it is preferred that the tempered glass according to the one embodiment of the present invention further comprise 0.01 mass to 0.1 mass of ZrO₂, 0.001 mass to 0.01 mass of K₂O, and 0.01 mass to 0.1 mass of CaO.

In addition, it is preferred that the tempered glass according to the one embodiment of the present invention have a bending processed portion.

In addition, it is preferred that the tempered glass according to the one embodiment of the present invention have a compressive stress value of a compressive stress layer of 500 MPa or more and a depth of layer of the compressive stress layer of 15 μm or more. Herein, the “compressive stress value” and the “depth of layer” refer to values calculated by observing the number of interference fringes and intervals between the fringes by using a surface stress meter (for example, FSM-6000 manufactured by Orihara Industrial Co., Ltd.).

In addition, it is preferred that the tempered glass according to the one embodiment of the present invention have a softening point of 750° C. or less. Herein, the “softening point” refers to a value measured based on a method of ASTM C338.

In addition, it is preferred that the tempered glass according to the one embodiment of the present invention have an annealing point of 600° C. or less. Herein, the “annealing point” refers to a value measured based on a method of ASTM C336.

In addition, it is preferred that the tempered glass according to the one embodiment of the present invention have a strain point of 500° C. or more. Herein, the “strain point” refers to a value measured based on a method according to ASTM C336.

In addition, it is preferred that the tempered glass according to the one embodiment of the present invention have a temperature at a viscosity at high temperature of 10^{4.0} dPa·s of 1,100° C. or less. Herein, the “temperature at a viscosity at high temperature of 10^{4.0} dPa·s” refers to a value measured by a platinum sphere pull up method.

In addition, it is preferred that the tempered glass according to the one embodiment of the present invention have a value represented by (temperature at a viscosity at high temperature of 10^{4.0} dPa·s)−(softening point) of 300° C. or more.

In addition, it is preferred that the tempered glass according to the one embodiment of the present invention have a liquidus temperature of 1,050° C. or less. Herein, the “liquidus temperature” refers to a value obtained as follows: glass is pulverized; then glass powder that passes through a standard 30-mesh sieve (sieve opening: 500 μm) and remains on a 50-mesh sieve (sieve opening: 300 μm) is placed in a platinum boat and kept for 24 hours in a gradient heating furnace; and a temperature at which a crystal is deposited is measured.

In addition, it is preferred that the tempered glass according to the one embodiment of the present invention have a liquidus viscosity of 10^{4.3} dPa·s or more. Herein, the “liquidus viscosity” refers to a value obtained by measuring the viscosity of glass at the liquidus temperature by a platinum sphere pull up method.

In addition, it is preferred that the tempered glass according to the one embodiment of the present invention have a thermal expansion coefficient of from 80×10⁻⁷/° C. to 110×10⁻⁷/° C. Herein, the “thermal expansion coefficient” refers to a value measured by using a dilatometer and shows an average value in the temperature range of from 30° C. to 380° C.

According to one embodiment of the present invention, there is provided a glass to be tempered, which is to be subjected to ion exchange treatment, the glass to be tempered comprising as a glass composition, in terms of mass %, 40% to 60% of SiO₂, 15% to 25% of Al₂O₃, 0% to 13.5% of B₂O₃, 12% to 24% of Na₂O, and 0% to less than 3% of MgO.

In addition, it is preferred that the glass to be tempered according to the one embodiment of the present invention comprise as a glass composition, in terms of mass %, 40% to 53% of SiO₂, 15% to 21% of Al₂O₃, 4% to 13.5% of B₂O₃, 17% to 24% of Na₂O, and 0.1% to less than 3% of MgO.

In addition, it is preferred that the glass to be tempered according to the one embodiment of the present invention comprise as a glass composition, in terms of mass %, 50% to 60% of SiO₂, 21% to 25% of Al₂O₃, 0% to 4% of B₂O₃, 3% to 6% of Li₂O, 12% to 17% of Na₂O, 0% to less than 3% of MgO, 0.1% to 3.5% of P₂O₅, and 0.1% to 5% of ZnO.

### DESCRIPTION OF EMBODIMENTS

A tempered glass of the present invention comprises as a glass composition, in terms of mass %, 40% to 60% of SiO₂, 15% to 25% of Al₂O₃, 0% to 13.5% of B₂O₃, 12% to 24% of Na₂O, and 0% to less than 3% of MgO. The reasons why the contents of the components are restricted within the above-mentioned ranges are described below. In the descriptions of the ranges of the contents of the components, the expression “%” represents “mass %” unless otherwise stated.

SiO₂ is a component which forms a glass network. The upper limit of the content range of SiO₂ is preferably 40% or more, 42% or more, 44% or more, 45% or more, 46% or more, 48% or more, or 49% or more, particularly preferably 50% or more, and the lower limit thereof is preferably 60% or less, 55% or less, 53% or less, 52% or less, 51% or less, 50% or less, or less than 50%, particularly preferably 49% or less. When the content of SiO₂ is too small, it becomes difficult to cause vitrification. In addition, a thermal expansion coefficient is excessively increased, with the result that thermal shock resistance is liable to be reduced. Meanwhile, when the content of SiO₂ is too large, meltability, formability, and bending processability are liable to be reduced.

Al₂O₃ is a component which improves ion exchange performance, and is also a component which increases a strain point and a Young's modulus. The content of Al₂O₃ is from 15% to 25%. A suitable upper limit of the content range of Al₂O₃ is 23% or less, 21% or less, 20% or less, or 19% or less, particularly 18.7% or less. A suitable lower limit of the content range of Al₂O₃ is 16% or more, 17% or more, or 18% or more, particularly 18.5% or more. When the ion exchange performance is preferentially improved over devitrification resistance, a suitable lower limit of the content range of Al₂O₃ is 19% or more, 20% or more, or 21% or more, particularly 22% or more. When the content of Al₂O₃ is too small, there is a risk in that the ion exchange performance cannot be exhibited sufficiently. Meanwhile, when the content of Al₂O₃ is too large, the meltability, the formability, and the bending processability are liable to be reduced. Further, a devitrified crystal is liable to be precipitated in the glass, and in particular, it becomes difficult to form a glass sheet by an overflow down-draw method or the like.

B₂O₃ is a component which reduces the softening point, and is also a component which reduces a liquidus temperature, a viscosity at high temperature, and a density. The content of B₂O₃ is from 0% to 13.5%. A suitable upper limit of the content range of B₂O₃ is 13% or less or 12.5% or less, particularly 12% or less. When the ion exchange performance is preferentially improved over a reduction in softening point, a suitable upper limit of the content range of B₂O₃ is 8% or less or 6% or less, particularly 4% or less. A suitable lower limit of the content range of B₂O₃ is 4% or more, 6% or more, 7.5% or more, 8% or more, 8.4% or more, 9% or more, 10% or more, or 11% or more, particularly 12% or more. When the content of B₂O₃ is too small, it becomes difficult to obtain the above-mentioned effects. Meanwhile, when the content of B₂O₃ is too large, the ion exchange performance, water resistance, a liquidus viscosity, the strain point, and the like are liable to be reduced.

The content of Al₂O₃+B₂O₃ is preferably from 25% to 35%, from 26% to 34%, or from 27% to 33%, particularly preferably from 28% to 32%. When the content of Al₂O₃+B₂O₃ is outside the above-mentioned ranges, it becomes difficult to achieve both the ion exchange performance and the bending processability. The “Al₂O₃+B₂O₃” refers to the total content of Al₂O₃ and B₂O₃.

Na₂O is a component which improves the ion exchange performance, and is also a component which improves the meltability, the formability, and the bending processability. Further, Na₂O is a component which improves the devitrification resistance. The content of Na₂O is from 12% to 24%. A suitable upper limit of the content range of Na₂O is 23% or less, 22.5% or less, 22% or less, 21.5% or less, or 21% or less, particularly 20.5% or less. When the strain point and the thermal shock resistance are preferentially maintained at the expense of the bending processability, a suitable upper limit of the content range of Na₂O is 20% or less, 19% or less, or 18% or less, particularly 17% or less. A suitable lower limit of the content range of Na₂O is 14% or more, 16% or more, 17% or more, 17.5% or more, 18% or more, 18.5% or more, 19% or more, or 19.5% or more, particularly 20% or more. When the content of Na₂O is too small, it becomes difficult to obtain the above-mentioned effects. Meanwhile, when the content of Na₂O is too large, the strain point tends to be reduced, and a component balance of the glass composition tends to be lost, with the result that the devitrification resistance is reduced contrarily. Further, the thermal expansion coefficient is excessively increased, with the result that the thermal shock resistance is reduced, and it becomes difficult to match the thermal expansion coefficient with those of peripheral materials.

From the viewpoint of expanding the range of selection of manufacturing conditions of thermal bending processing, the content of B₂O₃+Na₂O is preferably from 25% to 33%, from 26% to 32%, or from 27% to 31%, particularly preferably from 28% to 30%. When the content of B₂O₃+Na₂O is too small, the bending processability is liable to be reduced. Meanwhile, when the content of B₂O₃+Na₂O is too large, the liquidus viscosity and the strain point are liable to be reduced. The “B₂O₃+Na₂O” refers to the total content of B₂O₃ and Na₂O.

The content of Al₂O₃+B₂O₃+Na₂O is preferably 34% or more, 37% or more, 40% or more, 43% or more, 45% or more, or 47% or more, particularly preferably from 49% to 57%. With this, both the ion exchange performance and the bending processability are easily achieved. Herein, the “Al₂O₃+B₂O₃+Na₂O” refers to the total content of Al₂O₃, B₂O₃, and Na₂O.

The mass ratio Al₂O₃/Na₂O is preferably from 0.7 to 1.15, from 0.75 to 1.1, or from 0.8 to 1.05, particularly preferably from 0.85 to 1.0 from the viewpoint of expanding the range of selection of manufacturing conditions of thermal bending processing, and is preferably from 1.4 to 2.3, from 1.5 to 2.2, or from 1.6 to 2.1, particularly preferably from 1.7 to 2.0 from the viewpoints of increasing the Young's modulus and the specific Young's modulus. The mass ratio (Al₂O₃+B₂O₃)/(B₂O₃+Na₂O) is preferably from 0.7 to 1.15, from 0.75 to 1.1, or from 0.8 to 1.05, particularly preferably from 0.85 to 1.0 from the viewpoint of expanding the range of selection of manufacturing conditions of thermal bending processing, and is preferably from 1.4 to 2.2, from 1.5 to 2.1, or from 1.6 to 2.0, particularly preferably from 1.7 to 1.9 from the viewpoints of increasing the Young's modulus and the specific Young's modulus. The “Al₂O₃/Na₂O” refers to a value obtained by dividing the content of Al₂O₃ by the content of Na₂O. The “(Al₂O₃+B₂O₃)/(B₂O₃+Na₂O)” refers to a value obtained by dividing the total content of Al₂O₃ and B₂O₃ by the total content of B₂O₃ and Na₂O.

MgO is a component which improves the meltability, the formability, the bending processability, and the Young's modulus. However, when the content of MgO is too large, the glass is liable to be devitrified at the time of forming and bending processing. In addition, the ion exchange performance is liable to be reduced. Therefore, the content of MgO is from 0% to less than 3%, preferably from 0.1% to less than 3%, from 0.5% to 2.6%, from 1% to 2.4%, or from 1.5% to 2.2%, particularly preferably from 1.7% to less than 20.

In addition to the above-mentioned components, for example, the following components may be introduced.

Li₂O is a component which improves the ion exchange performance, and is also a component which improves the meltability, the formability, and the bending processability. However, when the content of Li₂O is too large, the liquidus viscosity is reduced, and the glass is liable to be devitrified at the time of forming and bending processing. Therefore, the content of Li₂O is preferably from 0% to 10%, from 0% to 8%, from 0% to 6%, from 0% to 4%, from 0% to 3%, from 0% to 2%, from 0% to 1%, or from 0% to 0.5%, particularly preferably from 0% to 0.1%. The glass is desirably substantially free of Li₂O (less than 0.01%). When the ion exchange performance and the bending processability are preferentially improved over the devitrification resistance, the content of Li₂O is preferably from 0.1% to 10%, from 1% to 8%, or from 2% to 7%, particularly preferably from 3% to 6%.

K₂O is a component which improves the ion exchange performance, and is also a component which has a high increasing effect on a depth of layer among alkali metal oxides. In addition, K₂O is a component which improves the meltability, the formability, and the bending processability. However, when the content of K₂O is too large, the strain point and the devitrification resistance are liable to be reduced. Therefore, a suitable upper limit of the content range of K₂O is 3% or less, 2% or less, 1% or less, 0.1% or less, 0.01% or less, 0.009% or less, or 0.008% or less, particularly 0.007% or less, and a suitable lower limit thereof is 0% or more, 0.001% or more, 0.003% or more, or 0.004% or more, particularly 0.005% or more.

Li₂O, Na₂O, and K₂O are each a component which improves the ion exchange performance, the meltability, the formability, and the bending processability. However, when the content of Li₂O+Na₂O+K₂O is too large, the strain point and the devitrification resistance are liable to be reduced. Therefore, a suitable lower limit of the content range of Li₂O+Na₂O+K₂O is 17% or more, 18% or more, or 19% or more, particularly 20% or more, and a suitable upper limit thereof is 27% or less or 25% or less, particularly 23% or less. The “Li₂O+Na₂O+K₂O” refers to the total content of Li₂O, Na₂O, and K₂O.

CaO is a component which improves the meltability, the formability, the bending processability, and the Young's modulus. However, when the content of CaO is too large, the density and the thermal expansion coefficient are excessively increased, the glass is liable to be devitrified, and the ion exchange performance is liable to be reduced. Therefore, the content of CaO is preferably from 0% to 0.5%, from 0.01% to 0.1%, from 0.02% to 0.09%, from 0.03% to 0.08%, or from 0.04% to 0.07%, particularly preferably from 0.05% to 0.06%.

SrO and BaO are each a component which improves the meltability, the formability, and the bending processability. When the content of SrO and BaO is too large, the ion exchange performance and the devitrification resistance are liable to be reduced. In addition, the density and the thermal expansion coefficient are excessively increased. Therefore, the total content of SrO and BaO (content of SrO+BaO) is preferably 3% or less, 2% or less, 1% or less, 0.8% or less, or 0.5% or less, particularly preferably 0.1% or less. The contents of SrO and BaO are each preferably 2% or less, 1% or less, 0.8% or less, or 0.5% or less, particularly preferably 0.1% or less.

When the content of MgO+CaO+SrO+BaO is too small, the meltability, the formability, the bending processability, and the Young's modulus are liable to be reduced. Meanwhile, when the content of MgO+CaO+SrO+BaO is too large, the ion exchange performance and the devitrification resistance are liable to be reduced. In addition, the density and the thermal expansion coefficient are excessively increased. Therefore, the content of MgO+CaO+SrO+BaO is preferably from 0.1% to less than 3%, from 0.5% to 2.6%, from 1% to 2.4%, or from 1.5% to 2.2%, particularly preferably from 1.7% to less than 2%. The “MgO+CaO+SrO+BaO” refers to the total content of MgO, CaO, SrO, and BaO.

When a value of the mass ratio (MgO+CaO+SrO+BaO)/(Li₂O+Na₂O+K₂O) is too large, the devitrification resistance tends to be reduced. Therefore, the value of the mass ratio (MgO+CaO+SrO+BaO)/(Li₂O+Na₂O+K₂O) is preferably 0.2 or less or 0.15 or less, particularly preferably 0.1 or less. The “(MgO+CaO+SrO+BaO)/(Li₂O+Na₂O+K₂O)” refers to a value obtained by dividing the total content of MgO, CaO, SrO, and BaO by the total content of Li₂O, Na₂O, and K₂O.

ZnO is a component which improves the ion exchange performance. In particular, ZnO is a component which increases a compressive stress value. In addition, ZnO is a component which reduces the viscosity at high temperature without reducing a viscosity at low temperature. However, when the content of ZnO is too large, the glass manifests phase separation, the devitrification resistance is reduced, and the density is liable to be increased. The content of ZnO is preferably from 0% to 5%, from 0.1% to 5%, from 0.1% to 3%, or from 0.1% to 2%, particularly preferably from 0.5% to 1%.

ZrO₂ is a component which improves the ion exchange performance, the strain point, and the liquidus viscosity. However, when the content of ZrO₂ is too large, the devitrification resistance may be excessively reduced. Therefore, the content of ZrO₂ is preferably from 0% to 0.5%, from 0.01% to 0.1%, from 0.02% to 0.09%, from 0.03% to 0.08%, or from 0.04% to 0.07%, particularly preferably from 0.05% to 0.08%.

TiO₂ is a component which improves the ion exchange performance, and is also a component which reduces the viscosity at high temperature. However, when the content of TiO₂ is too large, the glass is colored and the devitrification resistance is liable to be reduced. Therefore, the content of TiO₂ is preferably from 0% to 1% or from 0% to 0.5%, particularly preferably from 0% to 0.1%.

P₂O₅ is a component which improves the ion exchange performance. In particular, P₂O₅ is a component which increases the depth of layer. However, when the content of P₂O₅ is too large, the glass manifests phase separation and the water resistance is liable to be reduced. Therefore, the content of P₂O₅ is preferably 8% or less, 5% or less, 4% or less, 2% or less, 1% or less, 0.5% or less, or 0.2% or less, particularly preferably 0.1% or less. When the depth of layer is preferentially increased at the expense of the water resistance, the content of P₂O₅ is preferably from 0.1% to 5%, from 0.1% to 3.5%, from 0.3% to 3.5%, or from 0.2% to 3%, particularly preferably from 0.5% to 2%.

As a fining agent, one kind or two or more kinds selected from the group consisting of As₂O₃, Sb₂O₃, CeO₂, SnO₂, F, Cl, and SO₃ may be introduced in an amount of from 0% to 2%. It is preferred to use As₂O₃, Sb₂O₃, and F in an amount as small as possible from the environmental viewpoints, and each content thereof is preferably less than 0.1%. The fining agent is preferably one kind or two or more kinds selected from the group consisting of SnO₂, SO₃, and Cl, particularly preferably SnO₂. The content of SnO₂ is preferably from 0% to 1% or from 0.01% to 0.5%, particularly preferably from 0.1% to 0.6%. When the content of SnO₂ is too large, the devitrification resistance is liable to be reduced. The content of SO₃ is preferably from 0% to 0.1%, from 0.0001% to 0.1%, from 0.0003% to 0.08%, or from 0.0005% to 0.05%, particularly preferably from 0.001% to 0.03%. When the content of SO₃ is too large, SO₃ reboils at the time of melting, with the result that bubble quality is liable to be reduced. The content of Cl is preferably from 0% to 0.5%, from 0% to 0.1%, from 0% to 0.09%, or from 0% to 0.05%, particularly preferably from 0.001% to 0.03%. When the content of Cl is too large, metal wiring is liable to be eroded at the time of forming a metal wiring pattern or the like on the tempered glass.

Transition metal oxides, such as CoO₃ and NiO, are components which cause intense coloration of glass to reduce a transmittance. Therefore, the content of the transition metal oxides is preferably 0.5% or less or 0.1% or less, particularly preferably 0.05% or less in terms of a total content. It is desired to control the amount of impurities in raw materials and/or cullet of the glass so that the content of the transition metal oxides falls within such ranges.

Rare earth oxides, such as Nd₂O₃ and La₂O₃, are components which increase the Young's modulus. However, the cost of the raw material itself is high, and when the rare earth oxides are contained in a large amount, the devitrification resistance is liable to be reduced. Therefore, the content of the rare earth oxides is preferably 3% or less, 2% or less, 1% or less, or 0.5% or less, particularly preferably 0.1% or less in terms of a total content.

It is preferred to use PbO and Bi₂O₃ in an amount as small as possible from the environmental viewpoints, and the contents thereof are each preferably less than 0.1%.

Components other than the above-mentioned components may be introduced, and the total content thereof is preferably 3% or less, particularly preferably 1% or less.

Suitable glass composition ranges can each be obtained by appropriately selecting suitable content ranges of the components. Of those, from the viewpoint of expanding the range of selection of manufacturing conditions of thermal bending processing, the glass preferably comprises as a glass composition, in terms of mass %, 40% to 53% of SiO₂, 15% to 21% of Al₂O₃, 4% to 13.5% of B₂O₃, 17% to 24% of Na₂O, and 0.1% to less than 3% of MgO. In addition, from the viewpoints of increasing the Young's modulus and the specific Young's modulus, the glass preferably comprises as a glass composition, in terms of mass %, 50% to 60% of SiO₂, 21% to 25% of Al₂O₃, 0% to 4% of B₂O₃, 3% to 6% of Li₂O, 12% to 17% of Na₂O, 0% to less than 3% of MgO, 0.1% to 3.5% of P₂O₃, and 0.1% to 5% of ZnO.

In the tempered glass of the present invention, the compressive stress value of the compressive stress layer is preferably 500 MPa or more or 600 MPa or more, particularly preferably 700 MPa or more. As the compressive stress value becomes higher, the mechanical strength of the tempered glass becomes higher. Meanwhile, when an excessively large compressive stress is formed in the surface, micro cracks are generated on the surface, and the mechanical strength of the tempered glass may be reduced contrarily. Further, the formation of an excessively large compressive stress in the surface may cause an excessively high internal tensile stress. Therefore, the compressive stress value is preferably 1,300 MPa or less.

The depth of layer is preferably 15 μm or more or 20 μm or more, particularly preferably 30 μm or more. As the depth of layer becomes larger, the tempered glass is less liable to be broken even when the tempered glass has a deep flaw. Meanwhile, when the depth of layer is too large, there is a risk in that the internal tensile stress is excessively increased. Therefore, the depth of layer is preferably 100 μm or less or 80 μm or less, particularly preferably less than 50 μm.

The internal tensile stress is preferably 200 MPa or less, 150 MPa or less, or 100 MPa or less, particularly preferably 70 MPa or less. As the internal tensile stress becomes smaller, the probability that the tempered glass is broken owing to an internal defect becomes lower. However, when the internal tensile stress is extremely small, the compressive stress value and the depth of layer are liable to be reduced excessively. Therefore, the internal tensile stress is preferably 15 MPa or more or 20 MPa or more, particularly preferably 30 MPa or more. The internal tensile stress refers to a value calculated by the following mathematical formula.

Internal tensile stress=(compressive stress value×depth of layer)/(thickness of glass-depth of layer×2)

Internal tensile stress (MPa)

Compressive stress value (MPa)

Depth of layer (μm)

Thickness of glass (μm)

It is preferred that the tempered glass of the present invention have the following characteristics.

The density is preferably 2.52 g/cm³ or less, 2.50 g/cm³ or less, 2.49 g/cm³ or less, or 2.48 g/cm³ or less, particularly preferably 2.45 g/cm³ or less. As the density becomes lower, the weight of the glass can be made lighter. The “density” refers to a value measured by a well-known Archimedes method.

The strain point is preferably 500° C. or more, 510° C. or more, or 520° C. or more, particularly preferably 530° C. or more. As the strain point becomes higher, the compressive stress layer is less liable to disappear through heat treatment. In addition, when the strain point is high, stress relaxation is less liable to occur at the time of ion exchange, and hence a high compressive stress value is easily ensured.

The annealing point is preferably 580° C. or less, 570° C. or less, or 560° C. or less, particularly preferably 550° C. or less. As the annealing point becomes lower, an annealing time period and a cooling time period after the thermal bending processing can be shortened more.

The softening point is preferably 750° C. or less, 720° C. or less, or 710° C. or less, particularly preferably 700° C. or less. As the softening point becomes lower, the thermal bending processing can be performed at lower temperature. As a result, the annealing time and cooling time after the thermal bending processing can be shortened. In addition, as the softening point becomes lower, burden on a mold becomes smaller when press molding is performed. Deterioration of a mold is often caused by a reaction between a metal material to be used for a mold and oxygen in the air, that is, an oxidation reaction. Such oxidation reaction allows the formation of a reaction product on the surface of the mold. As a result, press molding does not provide a predetermined shape in some cases. In addition, when the oxidation reaction occurs, ions in the glass are reduced to produce bubbles in some cases. The degree of the oxidation reaction varies depending on the press molding temperature or the softening point. As the press molding temperature and the softening point become lower, the oxidation reaction can be suppressed more.

The temperature at a viscosity at high temperature of 10^{4.0} dPa·s is preferably 1,100° C. or less or 1,080° C. or less, particularly preferably 1,050° C. or less. As the temperature at a viscosity at high temperature of 10^{4.0} dPa·s becomes lower, a forming temperature is reduced more, and hence the manufacturing cost of the tempered glass can be reduced more.

A value represented by (temperature at a viscosity at high temperature of 10^{4.0} dPa·s)−(softening point) is preferably 300° C. or more, 310° C. or more, 320° C. or more, or 330° C. or more, particularly preferably 340° C. or more. The thermal bending processing is performed in a temperature region between the temperature at a viscosity at high temperature of 10^{4.0} dPa·s and the softening point. Therefore, when the value represented by (temperature at a viscosity at high temperature of 10^{4.0} dPa·s)−(softening point) is too small, in the case where the thermal bending processing is performed in a high temperature region, a temperature range suitable for the thermal bending processing is narrowed, and hence the range of selection of manufacturing conditions of the thermal bending processing is narrowed.

The temperature at a viscosity at high temperature of 10^{2.5} dPa·s corresponds to a melting temperature, and is preferably 1,450° C. or less, 1,420° C. or less, 1,400° C. or less, 1,380° C. or less, or 1,350° C. or less, particularly preferably 1,320° C. or less. As the temperature at 10^{2.5} dPa·s becomes lower, burden on a manufacturing facility, such as a melting furnace, becomes smaller at the time of melting, and bubble quality can be improved more. That is, as the temperature at 10^{2.5} dPa·s becomes lower, the glass can be manufactured more inexpensively. The “temperature at a viscosity at high temperature of 10^{2.5} dPa·s” refers to a value measured by a platinum sphere pull up method.

The thermal expansion coefficient is preferably from 80×10⁻⁷/° C. to 110×10⁻⁷/° C., particularly preferably from 85×10⁻⁷/° C. to 100×10⁻⁷/° C. When the thermal expansion coefficient falls within the above-mentioned ranges, it becomes easy to match the thermal expansion coefficient with that of a peripheral member, such as a metal or an organic adhesive, thereby making it possible to prevent the separation of the peripheral member.

The liquidus temperature is preferably 1,050° C. or less or 1,000° C. or less, particularly preferably 950° C. or less. When the liquidus temperature is high, a devitrified crystal is liable to be precipitated at the time of forming. The liquidus viscosity is preferably 10^{4.3} dPa·s or more or 10^{4.5} dPa·s or more, particularly preferably 10^{5.0} dPa·s or more. When the liquidus viscosity is low, a devitrified crystal is liable to be precipitated at the time of forming.

The Young's modulus is preferably 70 GPa or more, 74 GPa or more, or from 75 GPa to 100 GPa, particularly preferably from 76 GPa to 90 GPa. The specific Young's modulus is preferably 28 GPa/g·cm³ or more, 30 GPa/g·cm³ or more, or from 31 GPa/g·cm⁻³ to 35 GPa/g·cm³, particularly preferably from 31.5 GPa/g·cm³ to 34 GPa/g·cm⁻³. When the Young's modulus or the specific Young's modulus is low, the glass is liable to be deflected when used as a cover glass. The “Young's modulus” may be calculated by a well-known resonance method, and the “specific Young's modulus” refers to a value obtained by dividing the Young's modulus by the density.

The thickness of the tempered glass (sheet thickness when the tempered glass has a sheet shape) is preferably 0.2 mm or more, 0.3 mm or more, or 0.5 mm or more, particularly preferably 0.7 mm or more. With this, the mechanical strength of the tempered glass can be maintained. Meanwhile, when the thickness of the tempered glass is large, the bending processability is liable to be reduced. Further, it becomes difficult to achieve weight saving of the tempered glass. Therefore, the thickness of the tempered glass is preferably 2.0 mm or less, 1.5 mm or less, or 1.0 mm or less, particularly preferably 0.85 mm or less.

It is preferred that the tempered glass of the present invention have an unpolished surface. It is particularly preferred that the entire effective surface except end edge areas be unpolished. In addition, the average surface roughness (Ra) of the unpolished surface is preferably 10 A or less or 5 A or less, particularly preferably 2 A or less. With this, an appropriate gloss can be imparted to the tempered glass. As a result, the tempered glass is easily applied to an exterior part. In addition, when the surface is unpolished, the tempered glass is less liable to be broken by a point impact. An unpolished glass sheet having high surface accuracy can be obtained when the molten glass is formed by an overflow down-draw method. Herein, the “average surface roughness (Ra)” refers to a value measured by a method in conformity with SEMI D7-97 “FPD Glass Substrate Surface Roughness Measurement Method.” In order to prevent a situation in which the glass is broken from an end surface (cut surface), an end edge region or the end surface is preferably subjected to chamfering processing.

The tempered glass of the present invention preferably has a bending processed portion, such as a bent portion or a curved portion. With this, the design property of an exterior part or the like can be improved.

The bent portion is formed preferably in at least one end edge area of the tempered glass having a rectangular shape, more preferably in opposing end edge areas. With this, when the tempered glass is applied to an exterior part or the like, its end surface is less liable to be exposed to an outside, and hence the design property of the exterior part or the like can be improved. Besides, a situation in which the tempered glass is broken from the end surface by a physical impact is easily prevented.

The tempered glass of the present invention preferably has a flat sheet portion and the bent portion. With this, when the tempered glass is applied to as an exterior part or the like, the flat sheet portion is allowed to correspond to an operating area of a touch panel, and the surface of the bent portion (excluding the end surface) is allowed to correspond to an external side surface. In addition, in the case of allowing the surface of the bent portion (excluding the end surface) to correspond to the external side surface, the end surface is less liable to be exposed to the outside, and a situation in which the tempered glass is broken from the end surface by a physical impact is easily prevented.

The curved portion is preferably formed in the overall width direction or in the overall length direction of the tempered glass. The curved portion is more preferably formed in the overall width direction and in the overall length direction of the tempered glass. With this, a stress is less liable to be concentrated in a specific portion, and when the tempered glass is applied to a window glass of an automobile or the like, the tempered glass is less liable to be broken by a physical impact. When the curved portion is formed in the overall width direction and in the overall length direction, it is preferred to set the degree of curve in the width direction and the degree of curve in the length direction to differ from each other. With this, the design property of the window glass of an automobile or the like can be improved.

A glass to be tempered of the present invention is a glass to be tempered, which is to be subjected to ion exchange treatment, the glass to be tempered comprising as a glass composition, in terms of mass %, 40% to 60% of SiO₂, 15% to 25% of Al₂O₃, 0% to 13.5% of B₂O₃, 12% to 24% of Na₂O, and 0% to less than 3% of MgO. With this, both the ion exchange performance and the bending processability can be achieved. In addition, the glass to be tempered of the present invention has technical features (suitable glass composition range, suitable characteristics, and the like) similar to those of the tempered glass of the present invention. Therefore, a detailed description of the glass to be tempered of the present invention is omitted for convenience.

The glass to be tempered of the present invention may be produced by placing a glass batch which is prepared to have a predetermined glass composition in a continuous melting furnace, melting the glass batch at from 1,500° C. to 1,650° C., fining the resultant, feeding the resultant to a forming apparatus, and forming the molten glass, and annealing the glass.

Various forming methods may be adopted as a forming method. For example, there may be adopted forming methods, such as down-draw methods (e.g., an overflow down-draw method, a slot down method, and a re-draw method), a float method, and a roll out method. In addition, the molten glass may be directly formed into a predetermined shape by press molding.

The glass to be tempered of the present invention is preferably formed by an overflow down-draw method. With this, a glass which is unpolished and has improved surface quality can be produced. This is because in the case of adopting the overflow down-draw method, a surface to be the surface of the glass sheet does not come into contact with a trough-shaped refractory, and is formed in the form of a free surface. Herein, the overflow down-draw method is a method in which a molten glass is allowed to overflow from both sides of a heat-resistant trough-shaped structure, and the overflown molten glasses are down-drawn downwardly while combining them at the lower end of the trough-shaped structure, to thereby produce a glass to be tempered having a flat sheet shape.

The tempered glass can be obtained by subjecting the glass to be tempered to ion exchange treatment. The ion exchange treatment may be performed by, for example, immersing the glass to be tempered in a KNO₃ molten salt at from 400° C. to 550° C. for from 1 hour to 8 hours. The conditions of the ion exchange treatment may be optimally selected in consideration of the viscosity characteristics, applications, thickness, internal tensile stress, or the like of the glass.

The thermal bending processing is preferably performed on a glass to be tempered before the ion exchange treatment, and also the grinding and/or polishing of the end surface is preferably performed on the glass to be tempered before the ion exchange treatment. Further, it is also preferred to perform the grinding and/or polishing of the end surface after the thermal bending processing in order to remove the dimensional error or the like after the thermal bending processing.

The thermal bending processing is preferably performed on a glass to be tempered having a flat sheet shape. In addition, as a preferred thermal bending processing method, there is given a method involving subjecting the glass to be tempered having a flat sheet shape to press molding with a mold. With this, the dimensional accuracy of the glass to be tempered can be increased after the thermal bending processing.

In addition, as another preferred thermal bending processing method, there is given a method involving sandwiching the glass to be tempered having a flat sheet shape in a sheet thickness direction with a certain mold to support the glass to be tempered, to thereby allow elastic deformation of the glass to be tempered into a curved state, and then, while keeping this state, subjecting the glass to be tempered, which has been elastically deformed, to heat treatment, to thereby obtain a glass to be tempered having a curved portion (particularly a glass to be tempered having a curved portion in which the entire glass is curved in an arc in a sheet width direction). By such method, a flaw to be caused on the surface of the glass to be tempered owing to displacement or the like in association with the operation of allowing the elastic deformation can be suitably avoided. As a result, a defect or a flaw can be prevented on the surface of the curved portion as much as possible.

A temperature of the thermal bending processing is preferably (annealing point−10°) C. or more, (annealing point−5)° C. or more, or (annealing point+5)° C. or more, particularly preferably (annealing point+20)° C. or more. With this, the thermal bending processing can be performed in a short time period. Meanwhile, the temperature of the thermal bending processing is preferably (softening point−5)° C. or less, (softening point−15)° C. or less, or (softening point−20)° C. or less, particularly preferably (softening point−30)° C. or less. With this, surface smoothness is less liable to be impaired through the thermal bending processing, and dimensional accuracy after the thermal bending processing can be improved as well.

### EXAMPLES

### Example 1

Now, the present invention is described in detail based on Examples. The following Examples are merely illustrative. The present invention is by no means limited to the following Examples.

Examples of the present invention (Nos. 1 to 10) are shown in Table 1.

TABLE 1

| Glass composition [mass %] | No. 1 | No. 2 | No. 3 | No. 4 | No. 5 | No. 6 | No. 7 | No. 8 | No. 9 | No. 10 |
|---|---|---|---|---|---|---|---|---|---|---|
| SiO₂ | 50.25 | 47.98 | 44.23 | 52.57 | 48.60 | 52.07 | 58.98 | 56.93 | 57.47 | 54.36 |
| Al₂O₃ | 15.59 | 18.56 | 18.45 | 18.59 | 18.48 | 18.67 | 21.91 | 21.85 | 22.05 | 24.69 |
| B₂O₃ | 12.78 | 8.45 | 12.60 | 8.46 | 12.62 | 4.25 | 0.00 | 2.16 | 0.00 | 2.13 |
| P₂O₅ | 0.00 | 0.00 | 0.00 | 0.00 | 0.00 | 0.00 | 1.04 | 1.04 | 1.04 | 1.02 |
| Li₂O | 0.00 | 0.00 | 0.00 | 0.00 | 0.00 | 0.00 | 3.88 | 3.87 | 3.90 | 3.82 |
| Na₂O | 18.96 | 22.57 | 22.44 | 18.08 | 17.97 | 22.70 | 12.63 | 12.60 | 12.71 | 12.44 |
| K₂O | 0.002 | 0.010 | 0.004 | 0.000 | 0.001 | 0.000 | 0.004 | 0.003 | 0.002 | 0.001 |
| MgO | 1.85 | 1.83 | 1.82 | 1.84 | 1.83 | 1.85 | 0.00 | 0.00 | 1.26 | 0.00 |
| CaO | 0.10 | 0.07 | 0.00 | 0.00 | 0.03 | 0.00 | 0.00 | 0.00 | 0.00 | 0.00 |
| ZnO | 0.00 | 0.00 | 0.00 | 0.00 | 0.00 | 0.00 | 1.47 | 1.46 | 1.48 | 1.45 |
| ZrO₂ | 0.01 | 0.07 | 0.00 | 0.00 | 0.01 | 0.00 | 0.00 | 0.00 | 0.00 | 0.00 |
| SnO₂ | 0.46 | 0.46 | 0.46 | 0.46 | 0.46 | 0.46 | 0.09 | 0.09 | 0.09 | 0.09 |
| Density [g/cm³] | 2.44 | 2.48 | 2.47 | 2.46 | 2.45 | 2.45 | 2.46 | 2.46 | 2.48 | 2.46 |
| Strain point [° C.] | 530 | 522 | 525 | 520 | 511 | 515 | 486 | 478 | 489 | 494 |
| Annealing point [° C.] | 567 | 558 | 561 | 555 | 545 | 552 | 528 | 518 | 530 | 535 |
| Softening point [° C.] | 740 | 735 | 736 | 721 | 700 | 736 | 738 | 718 | 738 | 743 |
| 10^{4.0} dPa · s [° C.] | 1,073 | 1,081 | 1,069 | 1,039 | 1,001 | 1,074 | 1,118 | 1,100 | 1,100 | 1,125 |
| 10^{3.0} dPa · s [° C.] | 1,270 | 1,275 | 1,257 | 1,232 | 1,180 | 1,266 | 1,329 | 1,309 | 1,298 | 1,325 |
| 10^{2.5} dPa · s [° C.] | 1,400 | 1,403 | 1,381 | 1,357 | 1,301 | 1,392 | 1,461 | 1,441 | 1,423 | 1,449 |
| 10^{4.0} dPa · s-softening | 334 | 346 | 334 | 318 | 302 | 339 | 380 | 383 | 362 | 383 |
| point [° C.] | | | | | | | | | | |
| Thermal expansion coefficient | 87 | 101 | 97 | 93 | 92 | 104 | 94 | 91 | 96 | 92 |
| [×10⁻⁷/° C.] (30° C.-380° C.) | | | | | | | | | | |
| Young's modulus [GPa] | 70 | 70 | 69 | 70 | 69 | 70 | 78 | 79 | 80 | 79 |
| Specific Young's modulus | 28.5 | 28.3 | 28.1 | 28.4 | 28.0 | 28.6 | 31.7 | 32.1 | 32.3 | 32.1 |
| [GPa/(g/cm³)] | | | | | | | | | | |
| Liquidus temperature [° C.] | 938 | 1,023 | 991 | 973 | 951 | 1,025 | Not | Not | 902 | 904 |
| | | | | | | | measured | measured | | |
| Liquidus viscosity [dPa · s] | 5.0 | 4.4 | 4.6 | 4.5 | 4.4 | 4.3 | Not | Not | 5.5 | 5.6 |
| | | | | | | | measured | measured | | |
| Compressive stress value | 793 | 718 | 783 | 752 | 735 | 587 | 711 | 702 | 905 | 932 |
| [MPa] | | | | | | | | | | |
| Depth of layer [μm] | 21 | 31 | 26 | 22 | 18 | 37 | 16 | 13 | 15 | 14 |

Each sample was prepared as described below. First, glass raw materials were blended so as to achieve the glass composition shown in the table, and the resultant was melted at 1,600° C. for 8 hours by using a platinum pot. Next, the molten glass was poured onto a carbon sheet and formed into a flat sheet shape. Various properties of the resultant glass sheet were evaluated.

The density is a value measured by a well-known Archimedes method.

The strain point and the annealing point are values measured based on a method of ASTM C336. The softening point is a value measured based on a method of ASTM C338.

The temperatures at viscosities at high temperature of 10^{4.0} dPa·s, 10^{3.0} dPa·s, and 10^{2.5} dPa·s are values measured by a platinum sphere pull up method.

The thermal expansion coefficient is a value measured with a dilatometer and is an average value in the temperature range of from 30° C. to 380° C.

The Young's modulus is a value measured by a flexural resonance method. In addition, the specific Young's modulus is a value obtained by dividing the Young's modulus by the density.

The liquidus temperature is a value obtained as follows: the glass is pulverized; then glass powder that passes through a standard 30-mesh sieve (sieve opening: 500 μm) and remains on a 50-mesh sieve (sieve opening: 300 μm) is placed in a platinum boat and kept for 24 hours in a gradient heating furnace; and a temperature at which a crystal is deposited is measured. The liquidus viscosity is a value obtained by measuring the viscosity of glass at a liquidus temperature by a platinum ball pull up method.

The samples were each immersed in a KNO₃ bath kept at 430° C. for 4 hours to be subjected to ion exchange treatment, to thereby obtain tempered glasses. In each of the tempered glasses, the compressive stress value and depth of layer of the compressive stress layer were measured by observing the number of interference fringes and the intervals of the interference fringes using a surface stress meter (FSM-6000 manufactured by Orihara Industrial Co., Ltd.). At the time of measurement, a refractive index was set to 1.52 and an optical elastic constant was set to 30 [(nm/cm)/MPa] for each sample.

In preparing each sample in the table, a molten glass was flown, formed into a flat sheet shape, and then the resultant was optically polished before the ion exchange treatment, for convenience of description of the present invention. When the tempered glass is manufactured on an industrial scale, the following procedure is preferred: the glass is formed into a flat sheet shape by an overflow down-draw method or the like, and cut processed into a rectangular shape; and then the glass in a state in which its surface is unpolished is subjected to ion exchange treatment, to thereby produce the tempered glass.

As apparent from Table 1, Sample Nos. 1 to 10, in each of which the glass composition was restricted to the predetermined range, had a compressive stress value of 587 MPa or more and a softening point of 743° C. or less. Therefore, Sample Nos. 1 to 10 each have satisfactory ion exchange performance and satisfactory bending processability.

### Example 2

With regard to Sample Nos. 1 to 10, a glass sheet having a thickness of 0.7 mm was produced by an overflow down-draw method, and press molded using a mold made of mullite at a temperature lower than the softening point by 30° C. Further, the glass sheet having been removed from the mold was immersed in a KNO₃ bath kept at 430° C. for 4 hours to be subjected to ion exchange treatment. Thus, tempered glasses each having a bending processed portion were produced.

### INDUSTRIAL APPLICABILITY

While the tempered glass of the present invention is suitable for, for example, a cover glass for a mobile phone, exterior parts for a mobile PC and the like, and window glasses for an automobile, a train, a ship, and the like, the tempered glass of the present invention is also suitable for a substrate for a magnetic disk, a substrate for a flat panel display, a substrate and a cover glass for a solar cell, a cover glass for a solid state image sensor, tableware, and an ampoule tube for medical purposes in addition to the above-mentioned applications.

1. A tempered glass, comprising as a glass composition, in terms of mass %, 40% to 60% of SiO₂, 15% to 25% of Al₂O₃, 0% to 13.5% of B203, 12% to 24% of Na₂O, and 0% to less than 3% of MgO.

2. The tempered glass according to claim 1, comprising as a glass composition, in terms of mass %, 40% to 53% of SiO₂, 15% to 21% of Al₂O₃, 4% to 13.5% of B203, 17% to 24% of Na₂O, and 0.1% to less than 3% of MgO.

3. The tempered glass according to claim 1, comprising as a glass composition, in terms of mass %, 50% to 60% of SiO₂, 21% to 25% of Al₂O₃, 0% to 4% of B203, 3% to 6% of Li₂O, 12% to 17% of Na₂O, 0% to less than 3% of MgO, 0.1% to 3.5% of P₂O₅, and 0.1% to 5% of ZnO.

4. The tempered glass according to claim 1, further comprising 0.01 mass % to 0.1 mass % of ZrO₂, 0.001 mass % to 0.01 mass % of K₂O, and 0.01 mass % to 0.1 mass % of CaO.

5. The tempered glass according to claim 1, wherein the tempered glass has a bending processed portion.

6. The tempered glass according to claim 1, wherein the tempered glass has a compressive stress value CS of a compressive stress layer of 500 MPa or more and a depth of layer DOL of the compressive stress layer of 15 μm or more.

7. The tempered glass according to claim 1, wherein the tempered glass has a softening point of 750° C. or less.

8. The tempered glass according to claim 1, wherein the tempered glass has an annealing point of 600° C. or less.

9. The tempered glass according to claim 1, wherein the tempered glass has a strain point of 500° C. or more.

10. The tempered glass according to claim 1, wherein the tempered glass has a temperature at a viscosity at high temperature of 10^{4.0} dPa·s of 1,100° C. or less.

11. The tempered glass according to claim 1, wherein the tempered glass has a value represented by (temperature at a viscosity at high temperature of 10^{4.0} dPa·s)−(softening point) of 300° C. or more.

12. The tempered glass according to claim 1, wherein the tempered glass has a liquidus temperature of 1,050° C. or less.

13. The tempered glass according to claim 1, wherein the tempered glass has a liquidus viscosity of 10^{4.3} dPa·s or more.

14. The tempered glass according to claim 1, wherein the tempered glass has a thermal expansion coefficient of from 80×10⁻⁷/° C. to 110×10⁻⁷/° C.

15. A glass to be tempered, which is to be subjected to ion exchange treatment, the glass to be tempered comprising as a glass composition, in terms of mass %, 40% to 60% of SiO₂, 15% to 25% of Al₂O₃, 0% to 13.5% of B₂O₃, 12% to 24% of Na₂O, and 0% to less than 3% of MgO.

16. The glass to be tempered according to claim 15, comprising as a glass composition, in terms of mass %, 40% to 53% of SiO₂, 15% to 21% of Al₂O₃, 4% to 13.5% of B₂O₃, 17% to 24% of Na₂O, and 0.1% to less than 3% of MgO.

17. The glass to be tempered according to claim 15, comprising as a glass composition, in terms of mass %, 50% to 60% of SiO₂, 21% to 25% of Al₂O₃, 0% to 4% of B203, 3% to 6% of Li₂O, 12% to 17% of Na₂O, 0% to less than 3% of MgO, 0.1% to 3.5% of P₂O₅, and 0.1% to 5% of ZnO.

18. The tempered glass according to claim 2, further comprising 0.01 mass % to 0.1 mass % of ZrO₂, 0.001 mass % to 0.01 mass % of K₂O, and 0.01 mass % to 0.1 mass % of CaO.

19. The tempered glass according to claim 3, further comprising 0.01 mass % to 0.1 mass % of ZrO₂, 0.001 mass % to 0.01 mass % of K₂O, and 0.01 mass % to 0.1 mass % of CaO.
